(19) United States
(12) Patent Application Publication
(10) Pub. No.: US 2021/0165911 A1
(43) Pub. Date: Jun. 3, 2021

(54) SYSTEM AND METHOD FOR IMPROVING SECURITY OF PERSONALLY IDENTIFIABLE INFORMATION

(71) Applicant: TRUATA LIMITED, Dublin 18 (IE)

(72) Inventors: Yangcheng HUANG, Dublin 18 (IE); Nikita RAJVANSHI, Dublin 18 (IE)

(73) Assignee: TRUATA LIMITED, Dublin 18 (IE)

(21) Appl. No.: 16/702,216

(22) Filed: Dec. 3, 2019

(51) Int. Cl. G06F 21/62; G06F 16/955; G06F 16/25; G06F 16/951; G06F 16/906

(52) U.S. Cl. CPC G06F 21/6254; G06F 16/955; G06F 16/906; G06F 16/951; G06F 16/252

(57) ABSTRACT

A system and method for improving security of personally identifiable information including a user's navigations through the internet stored in a data storage and retrieval system. The system and method prohibit a user from being uniquely identified by the information stored in the data storage and the retrieval system.

### BACKGROUND

Personal data is considered to be an extremely valuable resource in the digital economy. Estimates predict the total amount of personal data generated globally will hit 44 zettabytes by 2020; a tenfold jump from 4.4 zettabytes in 2013. Digital advertising companies make millions of dollars by mining this personal data in order to market products to consumers. However, digital thieves have been able to steal hundreds of millions of dollars' worth of personal data. In response, governments around the world have passed comprehensive laws governing the security measures required to protect personal data.

For example, the General Data Protection Regulation (GDPR) is the regulation in the European Union (EU) that imposes stringent computer security requirements on the storage and processing of “personal data” for all individuals within the EU and the European Economic Area (EEA). Article 4 of the GDPR defines “personal data” as “any information relating to an identified or identifiable natural person . . . who may be identified, directly or indirectly, in particular by reference to an identifier such as a name, an identification number, location data, an online identifier or to one or more factors specific to the physical, physiological, genetic, mental, economic, cultural or social identity of that natural person.” Further, under Article 32 of the GDPR “the controller and the processor shall implement appropriate technical and organizational measures to ensure a level of security appropriate to the risk.” Therefore, in the EU or EEA, location data that may be used to identify an individual must be stored in a computer system that meets the stringent technical requirements under the GDPR.

Similarly, in the United States the Health Insurance Portability and Accountability Act of 1996 (HIPAA) requires stringent technical requirements on the storage and retrieval of “individually identifiable health information.” HIPAA defines “individually identifiable health information” any information in “which there is a reasonable basis to believe the information may be used to identify the individual.” As a result, in the United States, any information that may be used to an identify an individual must be stored in a computer system that meets the stringent technical requirements under HIPPA.

However, “Unique in the Crowd: The Privacy Bounds of Human Mobility” by Montjoye et al. (Montjoye, Yves-Alexandre De, et al. “Unique in the Crowd: The Privacy Bounds of Human Mobility.” Scientific Reports, vol. 3, no. 1, 2013, doi:10.1038/srep01376), which is hereby incorporated by reference, demonstrated that individuals could be accurately identified by an analysis of their location data. Specifically, Montjoye′ analysis revealed that with a dataset containing hourly locations of an individual, with the spatial resolution being equal to that given by the carrier's antennas, merely four spatial-temporal points were enough to uniquely identify 95% of the individuals. Montjoye further demonstrated that by using an individual's resolution and available outside information, the uniqueness of that individual's mobility traces could be inferred.

The ability to uniquely identify an individual based upon location information alone was further demonstrated by “Towards Matching User Mobility Traces in Large-Scale Datasets” by Kondor, Daniel, et al. (Kondor, Daniel, et al. “Towards Matching User Mobility Traces in Large-Scale Datasets.” IEEE Transactions on Big Data, 2018, doi:10.1109/tbdata.2018.2871693.), which is hereby incorporated by reference. Kondor used two anonymized “low-density” datasets containing mobile phone usage and personal transportation information in Singapore to find out the probability of identifying individuals from combined records. The probability that a given user has records in both datasets would increase along with the size of the merged datasets, but so would the probability of false positives. The Kondor's model selected a user from one dataset and identified another user from the other dataset with a high number of matching location stamps. As the number of matching points increases, the probability of a false-positive match decreases. Based on the analysis, Kondor estimated a matchability success rate of 17 percent over a week of compiled data and about 55 percent for four weeks. That estimate increased to about 95 percent with data compiled over 11 weeks.

Montjoye and Kondor concluded that an individual may be uniquely identified by their location information alone. Therefore, since the location data may be used to uniquely identify an individual, the location data may be considered “personal data” under GDPR and “individually identifiable health information” under HIPAA.

Application X entitled “A SYSTEM AND METHOD FOR IMPROVING SECURITY OF PERSONALLY IDENTIFIABLE INFORMATION”, which is hereby incorporated by reference, describes an approach for anonymizing user's location information as the user moves in physical space.

Application Z entitled “A SYSTEM AND METHOD FOR IMPROVING SECURITY OF PERSONALLY IDENTIFIABLE INFORMATION”, which is hereby incorporated by reference, describes an approach for anonymizing user's financial transaction information as the user makes a sequence of purchases from different merchants.

However, the ability to uniquely identify an individual by their tracked movements is not limited to motion in physical space. Similarly, a user's movements through “virtual spaces” (such as the internet) may be used to uniquely identify an individual. Similar to a sequence of timestamped GPS coordinates are a sequence of timestamped URLs visited by the user. As a result, the sequence of timestamped URLs visited by the user may be considered “personal data” under GDPR and “individually identifiable health information” under HIPAA, so may be.

As a result, the records regarding a user's navigations through the internet must be maintained in a data storage and retrieval system in such a way that it prohibits a user from being uniquely identified by the information stored in the data storage and the retrieval system. It is, therefore, technically challenging and economically costly for organizations and/or third parties to use gathered personal data in a particular way without compromising the privacy integrity of the data.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a schematic representation of a system that utilizes aspects of the secure storage method;

FIG. 1B is a schematic representation of an example anonymization server;

FIG. 2 is a graphical display of an example of “browsing history” data;

FIGS. 3A and 3B are graphical representations of a prior art method of anonymizing trajectory data;

FIG. 4A is a diagram of a communication diagram between components in accordance with an embodiment;

FIG. 4B is a diagram of a communication diagram between components in accordance with an embodiment;

FIG. 4C is a diagram of a communication diagram between components in accordance with an embodiment;

FIG. 5 is a process flow diagram of an example of the secure storage method;

FIG. 6A illustrates an example process to partition trajectories;

FIGS. 6B and 6C illustrate examples of partition trajectories;

FIG. 7 illustrates an example method to determine the similarity between trajectory partitions; and

FIGS. 8A and 8B illustrate an example process to generate the anonymized trajectories.

### DETAILED DESCRIPTION OF THE PREFERRED EMBODIMENTS

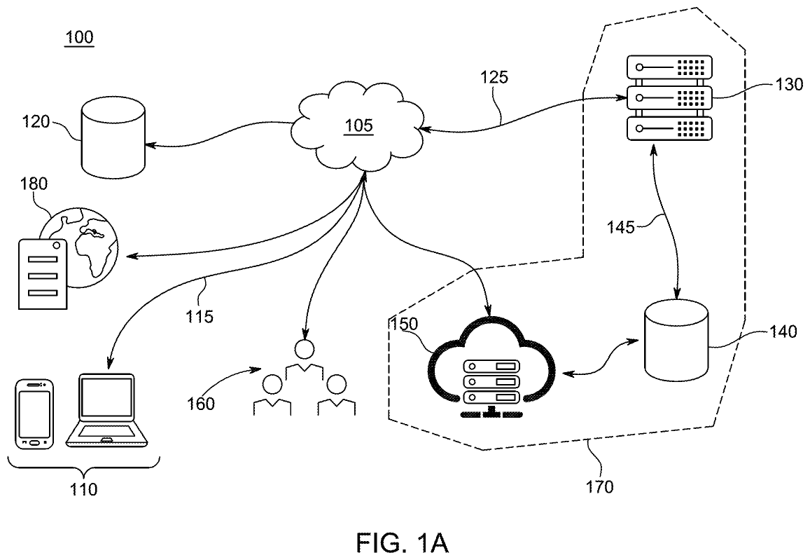

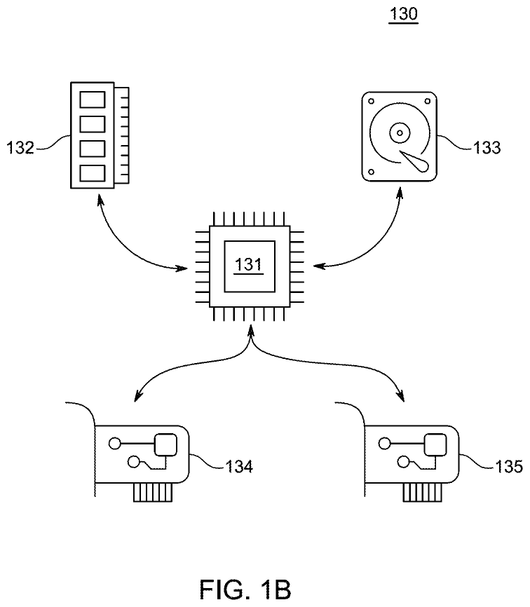

FIG. 1A is a diagram illustrating the components of the system 100. In system 100, an internet browser installed on a user device 110 is used to navigate the internet. In some instances, the user device may be a laptop, desktop, tablet computer or a mobile phone. The browser may be of any form known in the art such as Google Chrome®, Microsoft Internet Explorer®, Apple Safari® or Mozilla Firefox®. The browser enables the user to access the websites on the internet by entering a Uniform Resource Locator (URL). The URL uniquely identifies each of the billions of individual webpages on the internet 105. The browser also maintains a “browsing history” that includes a time and date stamp for each URL entered.

In many instances, the “browsing history” is stored in a User Identifiable Database 120. The “browsing history” may be sent across the wired or wireless communication channel 115 using various short-range wireless communication protocols (e.g., Wi-Fi), various long-range wireless communication protocols (e.g., TCP/IP, HTTP, 3G, 4G (LTE), 5G (New Radio)) or a combination of various short-range and long-range wireless communication protocols.

In some cases, a server 180 that hosts a website also collects “additional data” about the user's access patterns to the website. For example, the server 180 may collect “additional data” that includes time of access, screen resolution, the amount of time a user spent on a given page, their click-through rate and other server-side observations, referring/exit pages, the files viewed on the site (e.g., HTML pages, graphics, etc.), information related to the browsers (browser type, version, installed browser add-ons) or any other software clients used to access the websites, information related to the devices (device type, operating system, version, available fonts), truncated IP addresses of the connections, or third-party IDs from third parties (for the purpose of improving ID syncing.) Such information may be used to categorize the user and infer the contents of the pages accessed, further to infer gender, age, family status (number of children and their ages), education level, and gross yearly household income. In some instances, the server 180 may install a tracking cookie on the user device 110. A tracking cookie is a small piece of data sent from a server 180 and stored on the user's device 110 by the user's web browser while the user is browsing. This enables the server 180 to collect more detailed “additional data” about the user's internet usage. In other instances the server 180 will recognize the user by means of a user log-in at the website. For example, a user may log in to a web shop, a news portal, a social media service or a content streaming service using their user credentials, allowing the server 180 to identify the user even if the user uses different user devices and/or different browsers.

In some embodiments a third party is collecting the “additional data” on behalf of the owner of the website or for their own purposes. Such third parties may be website traffic analytics companies (e.g., Webtrends®) or internet search engines (e.g., Google®) or internet advertising companies (e.g., DoubleClick®) who provide their services on many websites and therefore are able to collect “additional data” of specific users and user devices across large parts of the Internet. For the purpose of this disclosure the collection of data by such third parties shall be considered to be equivalent as the collection of data by server 180.

The User Identifiable Database 120 stores “browsing history” transmitted by the user device 110 so that the database stores information for a plurality of users. In some instances, a user may be permitted to access their own information that is stored in the User Identifiable Database 120. The User Identifiable Database 120 may be implemented using a structured database (e.g., SQL), a non-structured database (e.g., NOSQL) or any other database technology known in the art. In other cases, the “browsing history” may be stored in a file system, either a local file storage or a distributed file storage such as Hadoop File System (HDFS), or a blob storage such as AWS S3 and Azure Blob.

In some instances, the User Identifiable Database 120 may also receive the “additional data” collected by the server 180. The data may be transferred using Hypertext Transfer Protocol (HTTP), File Transfer Protocol (FTP), Simple Object Access Protocol (SOAP), Representational State Transfer (REST) or any other file transfer protocol known in the art. In some instances, the transfer of data between the server 180 and the User Identifiable Database 120 may be further secured using Transport Layer Security (TLS), Secure Sockets Layer (SSL), Hypertext Transfer Protocol Secure (HTTPS) or other know security techniques.

The User Identifiable Database 120 may run on a dedicated computer server or may be operated by a public cloud computing provider (e.g., Amazon Web Services (AWS)®).

The anonymization server 130 receives data stored in the User Identifiable Database 120 via the internet 105 using wired or wireless communication channel 125. The data may be transferred using Hypertext Transfer Protocol (HTTP), File Transfer Protocol (FTP), Simple Object Access Protocol (SOAP), Representational State Transfer (REST) or any other file transfer protocol known in the art. In some instances, the transfer of data between the anonymization server 130 and the User Identifiable Database 120 may be further secured using Transport Layer Security (TLS), Secure Sockets Layer (SSL), Hypertext Transfer Protocol Secure (HTTPS) or other security techniques known in the art. In some instances, the data received by the anonymization server 130 may be preprocessed by User Identifiable Database 120 to remove session identifies, user names and the like.

The anonymized database 140 stores the secure anonymized data received by anonymization server 130 executing the anonymization and secure storage method 500 (to be described hereinafter). In some instances, the secure anonymized data is transferred from the anonymization server 130 to the anonymization database 140 using wired or wireless communication channel 125. In other instances, the anonymization database 140 is integral with the anonymization server 130.

The anonymized database 140 stores the secure anonymized data so that data from a plurality of users may be made available to a third party 160 without the third party 160 being able to associate the secure anonymized data with the original individual. The secure anonymized data includes location and timestamp information. However, utilizing the system and method which will be described hereinafter, the secure anonymized data cannot be traced back to an individual user. The anonymized database 140 may be implemented using a structured database (e.g., SQL), a non-structured database (e.g., NOSQL) or any other database technology known in the art. The anonymized database 140 may run on a dedicated computer server or may be operated by a public cloud computing provider (e.g., Amazon Web Services (AWS)®).

An access server 150 allows the Third Party 160 to access the anonymized database 140. In some instances, the access server 150 requires the Third Party 160 to be authenticated through a user name and password and/or additional means such as two-factor authentication. Communication between the access server 150 and the Third Party 160 may be implemented using any communication protocol known in the art (e.g., HTTP or HTTPS). The authentication may be performed using Lightweight Directory Access Protocol (LDAP) or any other authentication protocol known in the art. In some instances, the access server 150 may run on a dedicated computer server or may be operated by a public cloud computing provider (e.g., Amazon Web Services (AWS) 0).

Based upon the authentication, the access server 150 may permit the Third Party 160 to retrieve a subset of data stored in the anonymized database 140. The Third Party 160 may retrieve data from the anonymized database 140 using Structured Query Language (e.g., SQL) or similar techniques known in the art. The Third Party 160 may access the access server 150 using a standard internet browser (e.g., Google Chrome®) or through a dedicated application that is executed by a device of the Third Party 160.

In one configuration, the anonymization server 130, the anonymized database 140 and the access server 150 may be combined to form an Anonymization System 170.

FIG. 1B is a block diagram of an example device anonymization server 130 in which one or more aspects of the present disclosure are implemented. The anonymization server 130 may be, for example, a computer (such as a server, desktop, or laptop computer), or a network appliance. The device anonymization server 130 includes a processor 131, a memory 132, a storage device 133, one or more first network interfaces 134, and one or more second network interfaces 135. It is understood that the device 130 optionally includes additional components not shown in FIG. 1B.

The processor 131 includes one or more of: a central processing unit (CPU), a graphics processing unit (GPU), a CPU and GPU located on the same die, or one or more processor cores, wherein each processor core is a CPU or a GPU. The memory 132 may be located on the same die as the processor 131 or separately from the processor 131. The memory 132 includes a volatile or non-volatile memory, for example, random access memory (RAM), dynamic RAM, or a cache.

The storage device 133 includes a fixed or removable storage, for example, a hard disk drive, a solid state drive, an optical disk, or a flash drive. The storage device 133 stores instructions enable the processor 131 to perform the secure storage methods described here within.

The one or more first network interfaces 134 are communicatively coupled to the internet 105 via communication channel 125. The one or more second network interfaces 135 are communicatively coupled to the anonymization database 140 via communication channel 145.

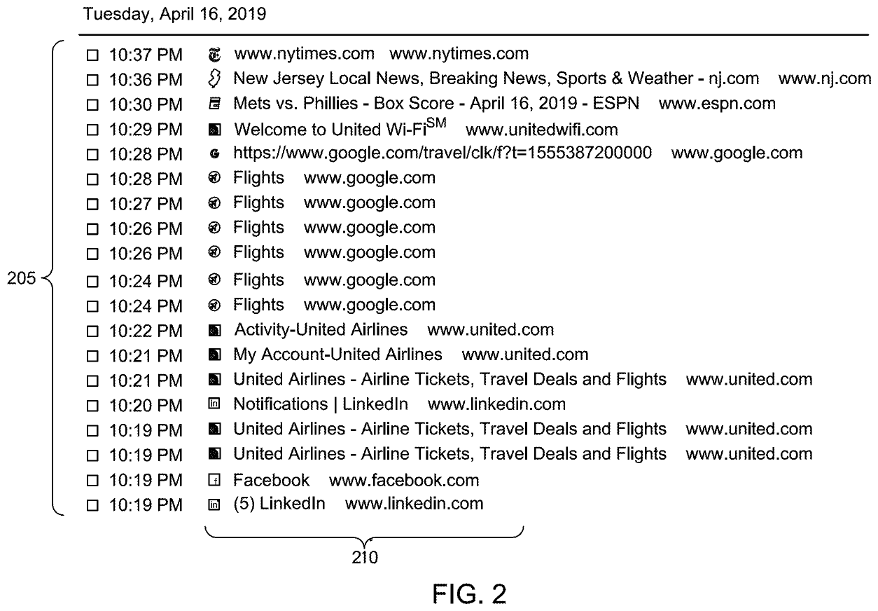

FIG. 2 illustrates an example of a “browsing history” for a particular user. For example, FIG. 2 illustrates a timestamps 205 for the websites 210 that a user visited on a particular day. Similar records may be maintained by a particular server that records all of the users that visit a particular website.

However, web browsing records are different from the structure of other data records. For example, a web browsing record is made of a sequence of location points where each point is labeled with a timestamp. As a result, orders between data points is the differential factor that leads to the high uniqueness of navigation trajectories. Further, the length of each trajectory doesn't have to be equal. This difference makes preventing identity disclosure in trajectory data publishing more challenging, as the number of potential quasi-identifiers is drastically increased.

As a result of the unique nature of the web browsing records, an individual user may be uniquely identified. Therefore, web browsing records must be processed and stored such that an original individual cannot be identified in order meet to the stringent requirements under GDPR and HIPPA.

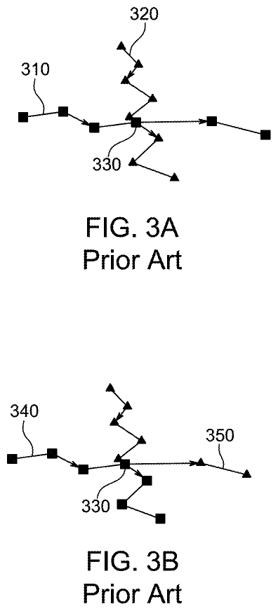

Existing solutions to the web browsing records problem, such as illustrated in FIG. 3A and FIG. 3B, randomly exchange parts of trajectories when two trajectories intersect. For example, FIG. 3A shows a first trajectory 310 (depicted with boxes) and a second trajectory 320 (depicted with triangles) that intersect at a point 330. The existing exchanging methods generate a third trajectory 340 (depicted with boxes) and a fourth trajectory 350 (depicted with triangles) as shown in FIG. 3B. The main drawback of existing trajectory exchanging methods is that some of the utilities of the exchanged trajectories are lost. For example, when exchanging trajectories between random users that have their path crossed, the nature of the movements is lost, and URL-based analytics is invalidated. Accordingly, it is desirable for a system to retain the utility of the original information without the information being able to be traced back to the original individual.

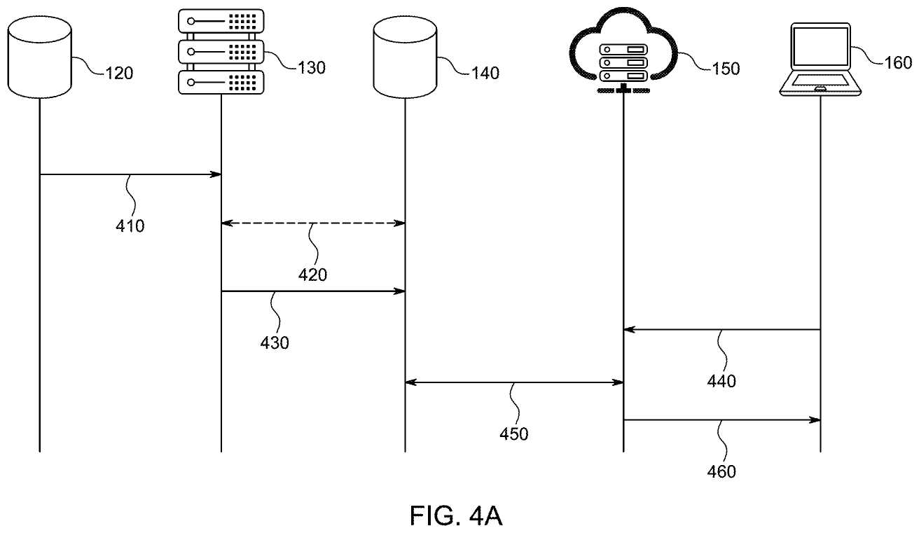

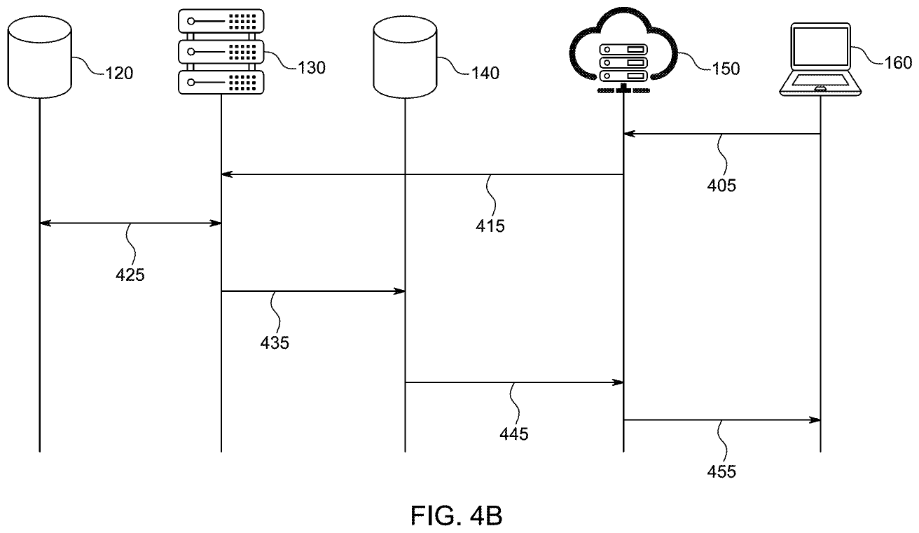

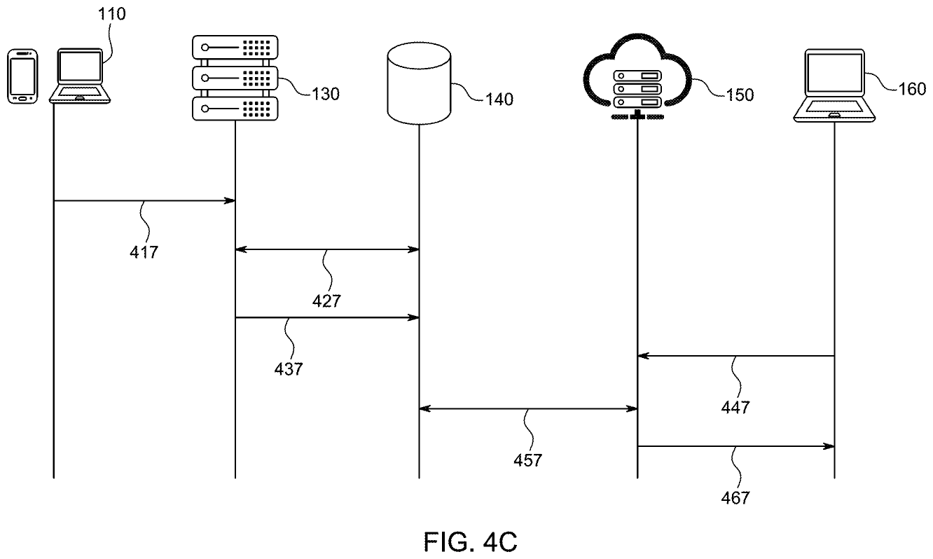

FIG. 4A is a diagram representing communication between components in accordance with an embodiment. In step 410 “browsing history” and any “additional data” is transmitted from the User Identifiable Database 120 to the anonymization server 130. The data that is transmitted from the User Identifiable Data 120 to the anonymization server 130 contains personally identifiable information of the individual users. In some instances, the data may be transmitted every time a new record is added to the User Identifiable Database 120. In other instances, the data may be periodically transmitted at a specified interval. In other instances, the data is transmitted in response to a request for the anonymization server 130. The data may be transmitted in step 410 using any technique known in the art and may utilize bulk data transfer techniques (e.g., Hadoop Bulk load).

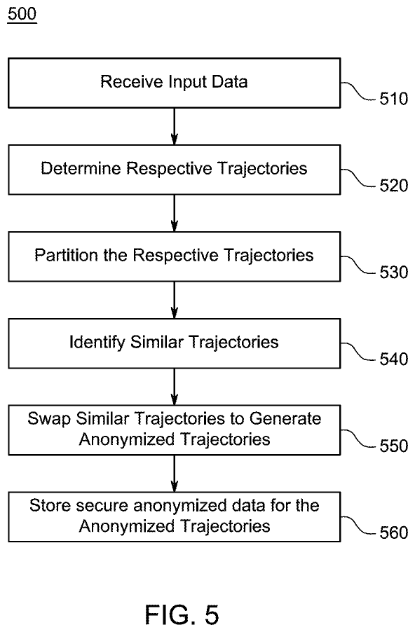

In some instances, in step 420 the anonymization server 130, retrieves secure anonymized data that has been previously stored in the anonymized database 140. The additional data retrieved in step 420 may be combined with the data received in step 410 and used as the input data for the secure storage method 500. In other instances, step 420 is omitted, and the anonymization server 130 performs the anonymization and secure storage method 500 (as shown in FIG. 5) using only the data received in step 410 as the input data.

In step 430, the secure anonymized data generated by anonymization server 130 is transmitted to the anonymized database 140. The data may be transmitted in step 430 using any technique known in the art and may utilize bulk data transfer techniques (e.g., Hadoop Bulk load).

The Third Party 160 retrieves the secure anonymized data from the anonymized database 140 by requesting the data from the server 150 in step 440. In many cases, this request includes an authentication of the Third Part 160. If the server 150 authenticates the Third Party 160, in step 450, the server 150 retrieves the secure anonymized data from the anonymized database 140. In step 460, the server 150 relays the secure anonymized data to the Third Party 160.

FIG. 4B is a diagram representing communication between components in accordance with an embodiment. In step 405, the Third Party 160 requests secure anonymized data from the anonymized database 140. The request may be submitted using a web form or any other method such as using an Application Programming Interface (API) that is provided by the server 150. For example, the Third Party 160 may request secure anonymized data for 25-40 year old men living in a certain region who have watched cat videos on the website YouTube® in the last 30 days.

In response, the server 150 determines that the requested secure anonymized data has not previously been stored in the anonymized database 140. The server 150 then requests (step 415) that the anonymization server 130 generate the requested secure anonymized data. In step 425, the anonymization server 130 retrieves, if required, the “browsing history” and any “additional information” required to generate the secure anonymized data from the User Identifiable Database 120. The data may be transmitted in step 425 using any technique known in the art and may utilize bulk data transfer techniques (e.g., Hadoop Bulk load).

In step 435, the secure anonymized data generated by anonymization server 130 is transmitted to the anonymized database 140. The data may be transmitted in step 435 using any technique known in the art and may utilize bulk data transfer techniques (e.g., Hadoop Bulk load). Then in step 445, the server 150 retrieves the secure anonymized data from the anonymized database 140. Then in step 455, the server 150 relays the secure anonymized data to the Third Party 160.

FIG. 4C is a diagram of a communication between components in accordance with an embodiment. In step 417 “browsing history” and any “additional data” is transmitted from the user device 110 to the anonymization server 130 for the user's personally identifiable information to be anonymized. The data may be transmitted in step 417 using Hypertext Transfer Protocol (HTTP), File Transfer Protocol (FTP), Simple Object Access Protocol (SOAP), Representational State Transfer (REST) or any other file transfer protocol known in the art.

It should be noted that when the requested anonymized data is already resident in the anonymization database 140, the third party 160 may request the data and the data may retrieved from the anonymization database 140 without requiring communication between the anonymization server 130 and the user identifiable database 120.

Then, in step 427 the anonymization server 130, retrieves secure anonymized data that has been previously stored in the anonymized database 140. The additional data retrieved in step 420 may be combined with the data received in step 410 and used as the input data for the anonymization and secure storage method 500.

In step 437, the secure anonymized data generated by anonymization server 130 is transmitted to the anonymized database 140. The data may be transmitted in step 430 using any technique known in the art and may utilize bulk data transfer techniques (e.g., Hadoop Bulk load).

The Third Party 160 retrieves the secure anonymized data from the anonymized database 140 by requesting the data for the server 150 in step 447. If the server authenticates the Third Party 160, in step 457, the server 150 retrieves the secure anonymized data from the anonymized database 140. Then in step 467, the server 150 relays the secure anonymized data to the Third Party 160.

FIG. 5 is a flow diagram of the anonymization and secure storage method 500. In step 510, “browsing data” and any “additional data” is received from the User Identifiable Database 120. Respective “navigation trajectories” are then determined for each of the plurality of users included in the data received in step 520. For example, a web browsing navigation trajectory may comprise: google search->Wikipedia_1->youtube->Wikipedia_2. Another web browsing may consist of google search->Wikipedia_1->Wikipedia_2->youtube->Wikipedia_1.

Then in step 530, the respective navigation trajectories identified in step 520 are partitioned; similar navigation trajectories are then identified based on the partitions (step 540). In step 550, the similar navigation trajectories identified in step 540 are exchanged. Then in step 560, secure anonymized data for the anonymized navigation trajectories generated in step 540 are stored in the anonymized database 140.

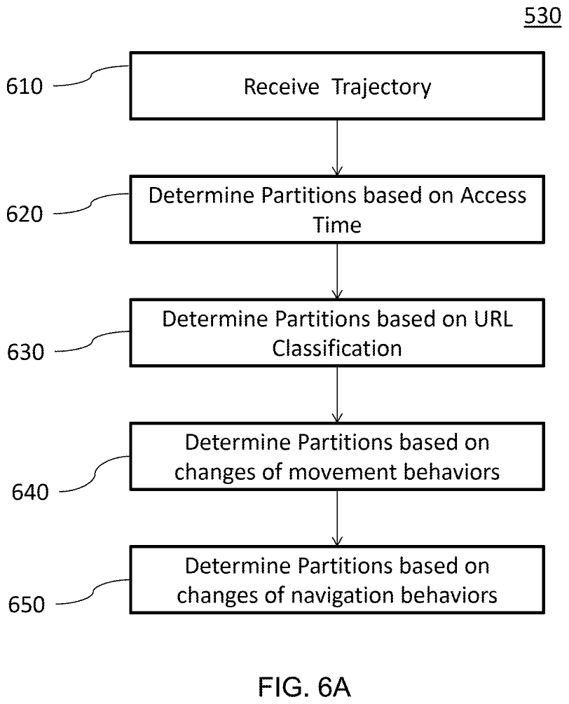

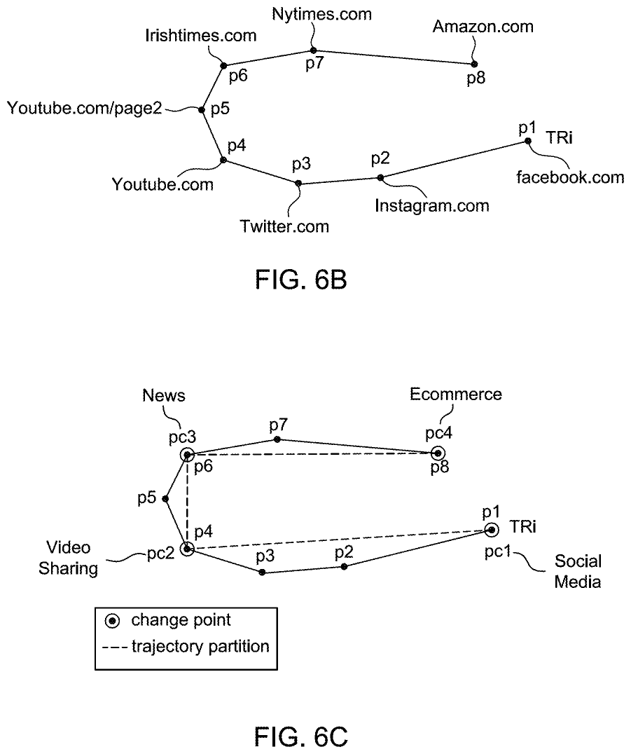

The process 530 of partitioning the navigation trajectories is graphically illustrated in FIGS. 6A and 6B. This process 530 finds a set of partition points where the behaviors of navigation change. These changes may include changes in the classification (e.g. “Social Media”, “News” etc.) of websites visited, or (contents of) pages visited (inferred from URLs), or changes of search terms, or changes of browsers and/or OS types, or changes of access methods to websites (for example, from mobile phones to PC, or to in-car devices or wearable devices). It is likely that different sessions might be interleaved and mixed. In this case, content and access time patterns may be prioritized in partition points selection against other factors.

In step 610, a navigation trajectory TRᵢ is received. An example of a navigation trajectory TRᵢ is depicted in FIG. 6B. TRᵢ is a sequence of multi-dimensional points denoted by TRᵢ=p1 p2 p3 . . . pi (1<i<n), where, pi (1<i<n) may be a d-dimensional point. For example, p1 may correspond to google.com, p2 to irishtimes.com etc.

The length i of a trajectory may be different from those of other trajectories. For instance, trajectory pc1 pc2 . . . pck (1<=c1<c2<<ck<i) be a sub-trajectory of TRi. A trajectory partition is a line partition pi pj (i<j), where pi and pj are two different points chosen from the same trajectory.

In step 620, the trajectory is divided into partitions based on the time the URLs were accessed. For example, the trajectories may be partitioned by grouping trajectories for the morning, afternoon and evening.

In step 630, the trajectory is further partitioned by classifying the URLs that comprise the trajectory. For example, the URLs may be classified as “Social Media”, “News”, “Video Sharing” or “Adult”. The classifications of the URLs may be made based on the “IAB Tech Lab Content Taxonomy” and may be implemented through API integration with a commercially available database such as provided by FortiGuard Labs.

In step 630, partitioning points are determined based on the user navigating from a URL with one type of content classification to another. For instance, the user navigating from a URL classified as “Social Media” (e.g., Facebook) to a URL classified as “Video Sharing” (e.g., YouTube) would be classified as a partitioning point. FIG. 6C illustrates examples partitioning points for the trajectory illustrated by FIG. 6B.

In step 640, partitioning points are determined based on the inferred site contents a user is navigating. The contents may be inferred simply from URLs, by parsing URLs based on URL structures and keywords. For example, the URL www.google.com/search?&q=marvel+movies implies a SEARCH query on MARVEL MOVIES, while the URL www.irishtimes.com/culture/film/latest-movies-reviewed-all-films-in-cinemas-this-week-rated-1.3886464 indicates a PAGE VIEWING access to MOVIE REVIEWs. Methods such as tokenization and natural language processing (NLP) can help parsing the URLs and infer the contents. Another method is to obtain the contents or pages that the user accesses and apply NLP to further determine the content of the pages.

Step 630 and step 640 may be combined, or applied separately, in partitioning the navigation trajectories.

Step 650 further partitions the trajectory based on changes of navigation behaviors. These changes may include changes of screen resolutions, changes of browsers and/or OS types, or changes of access methods to websites (for example, from mobile phones to PC, or to in-car devices or wearable devices).

For example, FIG. 6C illustrates partitioning points Pc1, Pc2, Pc3, and Pc4. Pc1 is determined to be a partition point based on time stamps (starting point of a sequence of web sessions). Pc2 is determined to be a partitioning point because the user navigated from youtube.com on which a user is accessing a movie trailer, to spotify.com on which the user starts to search music, also moves from a PC environment to a mobile phone app (based on information from URLs). Similarly, Pc3 is a partitioning point because the user navigated from spotify.com to amazon.com classified as online shopping website. Finally, Pc4 is a partitioning point based on time stamps (ending point of the web session sequence).

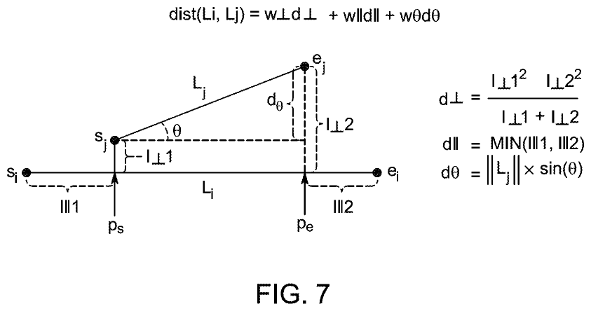

FIG. 7 illustrates an example method to determine the similarity between trajectory partitions as set forth in step 540 of FIG. 5. In step 540, the partitioned trajectory partitions are grouped based on their similarities. In the context of navigation trajectories, the similarity between trajectory partitions may be defined as “closeness” between partitions. For example, navigation from “Facebook” to “YouTube” may be considered “close” to a pattern of navigation from “LinkedIn” to “Hulu.”

An example implementation of step 540 is density-based clustering, e.g., grouping partitions based on their session sequence similarity measures between each other. In an example density-based clustering method, the similarity between two partitions is calculated based on weighted sum of the dimensions in FIG. 7.

In order to obtain optimal sequence matches, the session sequences may be shifted left or right to align as many URLs as possible.

In some instances, step 540 may utilize density-based clustering algorithms (i.e., DBSCAN) to find the similar partitions. Trajectory partitions that are close (e.g., similar) are grouped into the same cluster.

The parameters used in this similarity analysis may be determined either manually, or automatically by applying statistical analysis on all trajectories. For example, DBSCAN requires two parameters, E and minPts, the minimum number of partitions required to form a dense region. K-nearest neighbor.

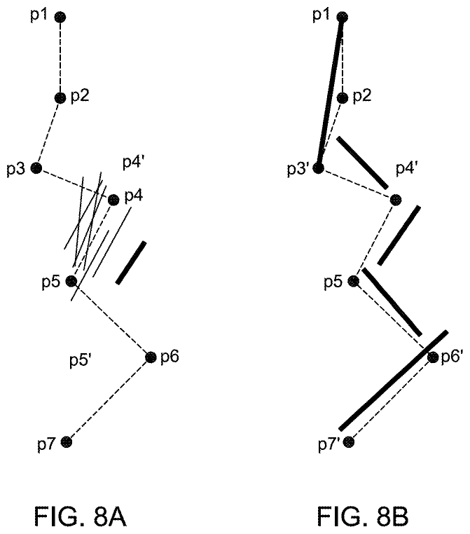

The results of the exchanging step 550 is illustrated in FIG. 8A and FIG. 8B. The purpose of the exchanging step 550 is to selectively shuffle partitions of multiple different trajectories based on the similarity partitions identified in step 540. For example, FIG. 8A shows the partitions p4 p5 has multiple similar partitions from other trajectories. To maximize the difference between the exchanged partitions and hence the anonymization effects, the partitions with the maximum distance from a particular partition is chosen as the exchange target (p4′p5′ in the figure).

During the exchanging step 550, the partitions are paired with the selected partitions, and exchanged between trajectories. Therefore, no partitions are dropped. If a partition is not in any of the clusters, the partition is left untouched.

After all partitions are exchanged, the trajectory is transformed into a set of disjoined or touching partitions as FIG. 8B. These segments are then re-assembled into the anonymized trajectory. As an example, if a partition is disjoined with another partition, a new partition is added to connect two partitions. In another implementation the partitions may be joined by moving the respective end-points of the parts together.

The secure anonymized data may then be generated from the anonymized trajectory without the secure anonymized data being able to be associated with a particular user.

Although features and elements are described above in particular combinations, one of ordinary skill in the art will appreciate that each feature or element may be used alone or in any combination with the other features and elements. In addition, a person skilled in the art would appreciate that specific steps may be reordered or omitted.

Furthermore, the methods described herein may be implemented in a computer program, software, or firmware incorporated in a computer-readable medium for execution by a computer or processor. Examples of computer-readable media include electronic signals (transmitted over wired or wireless connections) and non-transitory computer-readable storage media. Examples of non-transitory computer-readable storage media include, but are not limited to, a read-only memory (ROM), a random access memory (RAM), a register, cache memory, semiconductor memory devices, magnetic media, such as internal hard disks and removable disks, magneto-optical media, and optical media such as CD-ROM disks, and digital versatile disks (DVDs).

What is claimed is:

1. A system for improving security of personally identifiable information stored in an anonymized database, the system comprising:
a first communication interface that is communicatively coupled to a User Identifiable Database, wherein the User Identifiable Database stores a plurality of Uniform Resource Locators (URLs) and time records that are associate with unique individuals;
a second communication interface that is communicatively coupled to the anonymized database;
a memory; and
a processor that is communicatively coupled to the first communication interface, the second communication interface and the memory;
wherein the processor is configured to:
receive, using the first communication interface, the plurality of URLs and time records from the User Identifiable Database,
determine navigation trajectories for each of the unique individuals based on the plurality of URLs and time records received,
partition each of the navigation trajectories into a plurality of partitions,
identify similar trajectories in the plurality of partitions,
generate anonymized trajectories by exchanging the similar trajectories identified, and
store, using the second communication, anonymized location and time records in the anonymized database based on the anonymized trajectories generated.

2. The system according to claim 1, wherein the processor is configured to partition each of the navigation trajectories into the plurality of partitions based a particular time when a particular user visited a particular URL.

3. The system according to claim 1, wherein the processor is configured to partition each of the navigation trajectories into the plurality of partitions based on a classification of each of the plurality of URLs.

4. The system according to claim 3, wherein the processor is configured to partition each of the navigation trajectories into the plurality of partitions based on a change in classification of successive URLs navigated to by the user in respective navigation trajectories.

5. The system according to claim 1, wherein the plurality of Uniform Resource Locators (URLs) and time records are collected using tracking cookies.

6. The system according to claim 1, wherein the processor is configured to identify the similarities in the trajectories in the plurality of partitions based on a density-based clustering algorithm.

7. The system according to claim 1, wherein the processor is configured to identify the similarities in the trajectories in the plurality of partitions based on a weighted sum of a perpendicular distance (d_{⊥}), a parallel distance (d_{∥}), and angle distance (d_{θ}) between the plurality of partitions.

8. A method for improving security of personally identifiable information stored in an anonymized database, the method comprising:
receiving, by a processor, a plurality of URLs and time records from a User Identifiable Database, wherein the User Identifiable Database stores a plurality of Uniform Resource Locators (URLs) and time records that are associate with unique individuals;
determining, by the processor, navigation trajectories for each of the unique individuals based on the plurality of URLs and time records received;
partitioning, by the processor, each of the navigation trajectories into a plurality of partitions;
identifying, by the processor, similar trajectories in the plurality of partitions;
generating, by the processor, anonymized trajectories by exchanging the similar trajectories identified; and
storing, by the processor, anonymized location and time records in the anonymized database based on the anonymized trajectories generated.

9. The method according to claim 8, wherein each of the navigation trajectories are partitioned into the plurality of partitions based a particular time when a particular user visited a particular URL.

10. The method according to claim 8, wherein each of the navigation trajectories into the plurality of partitions are partitioned based on a classification of each of the plurality of URLs.

11. The method according to claim 8, wherein each of the navigation trajectories are partitioned into the plurality of partitions based on a change in classification of successive URLs navigated to by the user in respective navigation trajectories.

12. The method according to claim 8, wherein the plurality of Uniform Resource Locators (URLs) and time records are collected using tracking cookies.

13. The method according to claim 8, the similarities in the trajectories are identified in the plurality of partitions based on a density-based clustering algorithm.

14. The method according to claim 8, wherein the similarities in the trajectories in the plurality of partitions are identified based on a weighted sum of a perpendicular distance (d_{⊥}), a parallel distance (d_{∥}), and angle distance (d_{θ}) between the plurality of partitions.

15. A non-transitory computer readable storage medium that stores instructions that when executed by a processor cause the processor to:
receive, using a first communication interface, a plurality of URLs and time records from a User Identifiable Database, wherein the User Identifiable Database stores a plurality of Uniform Resource Locators (URLs) and time records that are associate with unique individuals;
determine navigation trajectories for each of the unique individuals based on the plurality of URLs and time records received;
partition each of the navigation trajectories into a plurality of partitions,
identify similar trajectories in the plurality of partitions;
generate anonymized trajectories by exchanging the similar trajectories identified, and
store, using a second communication, anonymized location and time records in an anonymized database based on the anonymized trajectories generated.

16. The non-transitory computer readable storage medium according to claim 15, wherein each of the navigation trajectories are partitioned into the plurality of partitions based a particular time when a particular user visited a particular URL.

17. The non-transitory computer readable storage medium according to claim 15, wherein each of the navigation trajectories into the plurality of partitions are partitioned based on a classification of each of the plurality of URLs.

18. The non-transitory computer readable storage medium according to claim 15, wherein each of the navigation trajectories are partitioned into the plurality of partitions based on a change in classification of successive URLs navigated to by the user in respective navigation trajectories.

19. The non-transitory computer readable storage medium according to claim 15, wherein the plurality of Uniform Resource Locators (URLs) and time records are collected using tracking cookies.

20. The non-transitory computer readable storage medium according to claim 15, the similarities in the trajectories are identified in the plurality of partitions based on at least a density-based clustering algorithm, a weighted sum of a perpendicular distance (d_{⊥}), a parallel distance (d_{∥}), and angle distance (d_{θ}) between the plurality of partitions.
